(19) United States
(12) Patent Application Publication
(10) Pub. No.: US 2011/0067309 A1
(43) Pub. Date: Mar. 24, 2011

(54) Child Safety Gate

(76) Inventors: Raimund Hofmann, Kreuzwertheim (DE); Jörg Hofmann, Karbach (DE)

(21) Appl. No.: 12/860,601

(22) Filed: Aug. 20, 2010

(30) Foreign Application Priority Data
Aug. 22, 2009 (DE) 20 2009 011 455.4

(51) Int. Cl. E05F 15/12; E06B 3/36; E06B 3/50; E06B 7/00

(52) U.S. Cl. 49/55; 49/50

(57) ABSTRACT

A child safety gate for doorways and stairwells comprising a gate, a swivel mounted on one or two supports, wherein said supports are vertically clamped in a doorway or stairwell, thereby creating no threshold.

### OBJECT OF THE INVENTION

To design a child safety gate for use in doorways and stairways which causes minimum constriction, requires no drilling or screwing, and which doesn't create a threshold that must be stepped over when the gate is open. The gate should also be adjustable in width and offer a clear view. It should be suitable for use with pets as well.

### BACKGROUND OF THE INVENTION

Child safety gates have been available in all sizes and shapes for many years now. One method of securing a child safety gate is to bolt it to the wall, causing damage to walls and doorways. Consumers want to avoid this damage. Some systems involve jamming the gate into the opening using a U-shaped frame, creating a stumbling block in the opening and making it more difficult to push a stroller through.

### SUMMARY OF THE INVENTION

The task is accomplished by designing the gate 8 in such a way that it rotates on joint 5, which is mounted on a vertical support. Joint 5 is a shaft equipped with a row of teeth and a bead to reduce friction. This eliminates threshold 19, leaving the passage completely free. The gate 8 can be mounted on support 1 and/or on the opposite support 2, using one or more fastenings 3.

The gate 8 is made adjustable in width by using two panels 4.

Two panels 4 are used with slat 6 to extend the width of the gate. The panels 4 are attached to each other using screws 13 and slide apart to adjust to the width of the passage. Slat 6 is either glued or screwed. The panels 4 can be delivered in see-through material in order to provide a clear view through the gate 8.

Supplemental brackets 22 can be used in front of and on the side of the doorway to avoid constricting the passage.

### BRIEF DESCRIPTION OF DRAWINGS

FIG. 1 displays a side perspective view of a support of a child safety gate in accordance with an example embodiment of the present invention.

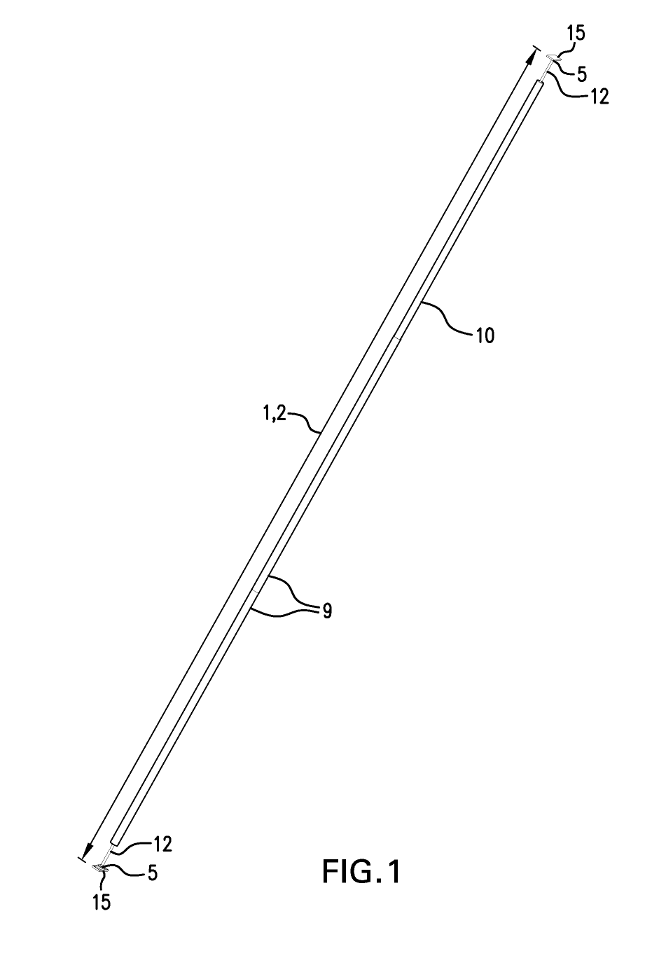

FIG. 2A displays a front perspective view of a fastening of the child safety gate in accordance with the example embodiment of the present invention.

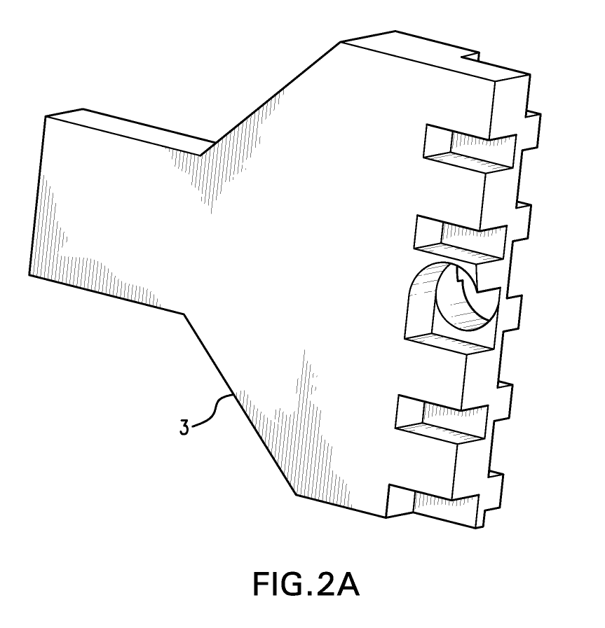

FIG. 2B displays a partial, front elevational view of a panel and fastening of the child safety gate in accordance with the example embodiment of the present invention.

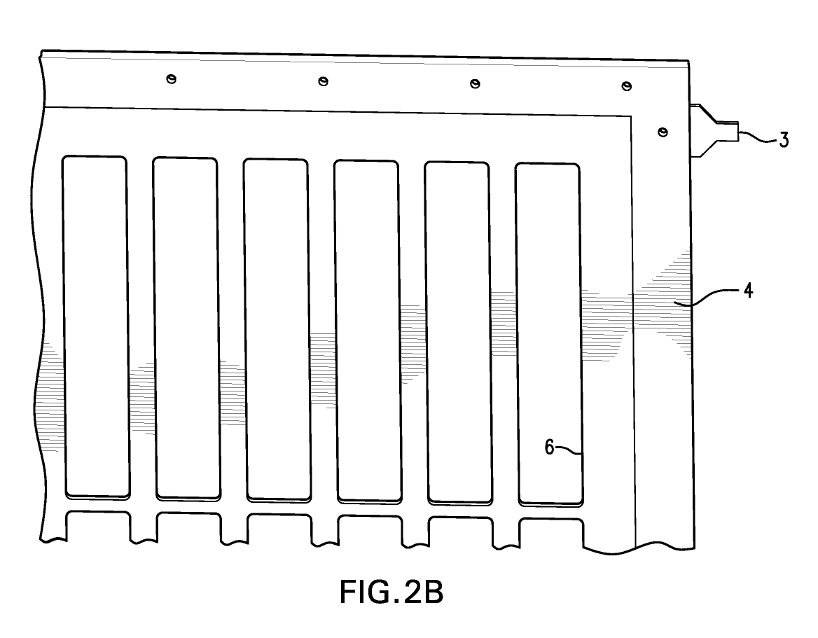

FIG. 3 displays a front perspective view of a panel of the child safety gate in accordance with the example embodiment of the present invention.

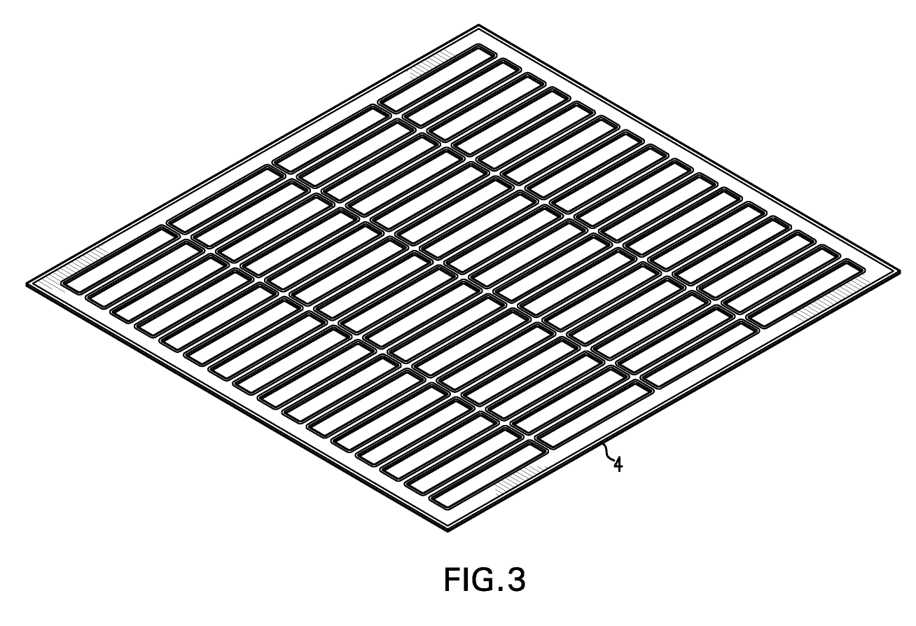

FIG. 4 displays a partial, front elevational view of a door frame and installed child safety gate in accordance with the example embodiment of the present invention.

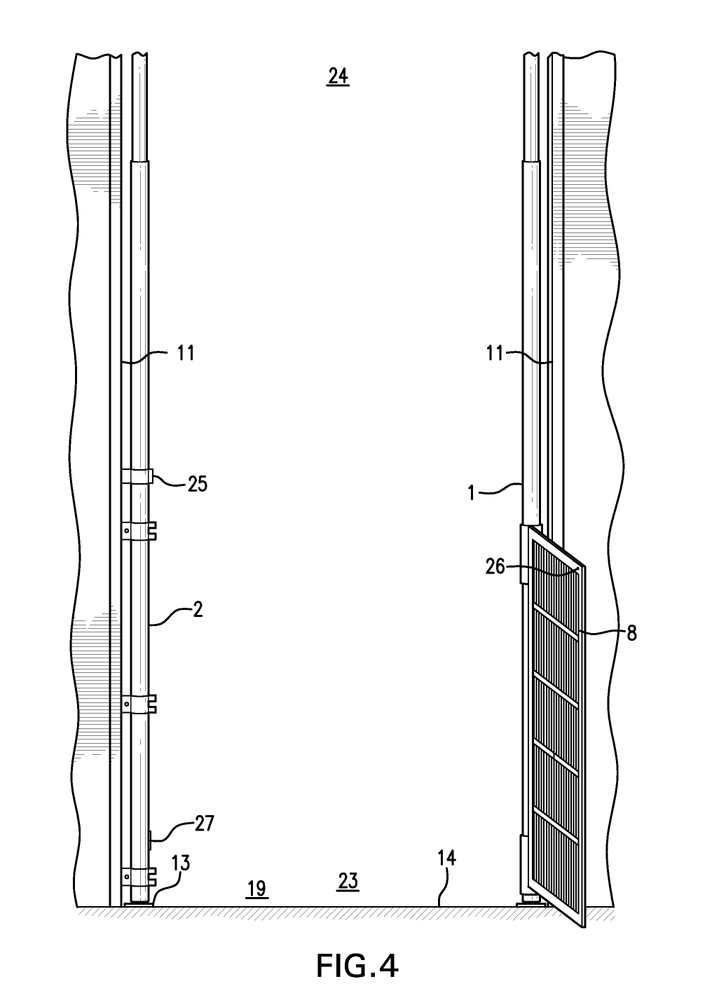

FIG. 5 displays a partial, front perspective view of a portion of the support of FIG. 1, in accordance with the example embodiment of the present invention, showing a swivel plate thereof.

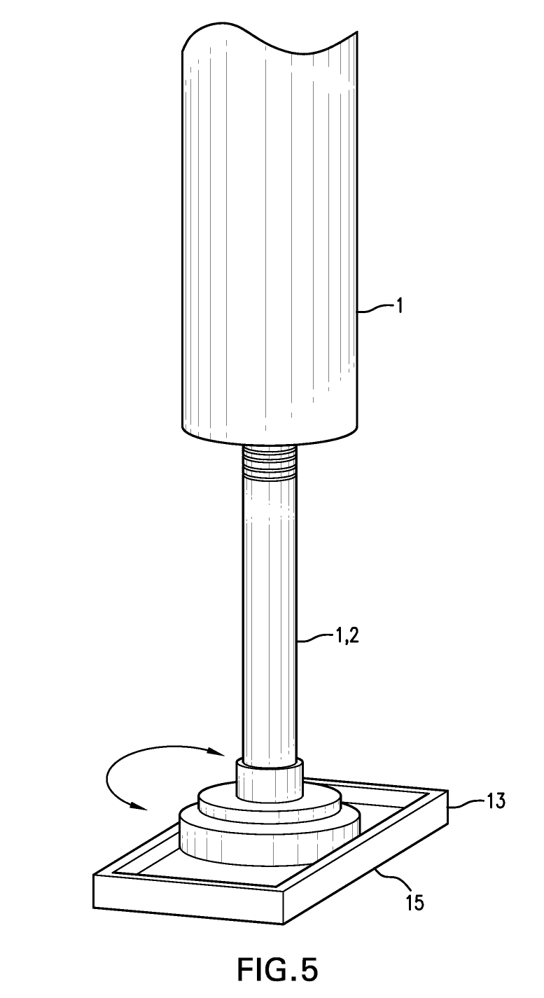

FIG. 6A displays a side, perspective view of a joint of the child safety gate in accordance with the example embodiment of the present invention.

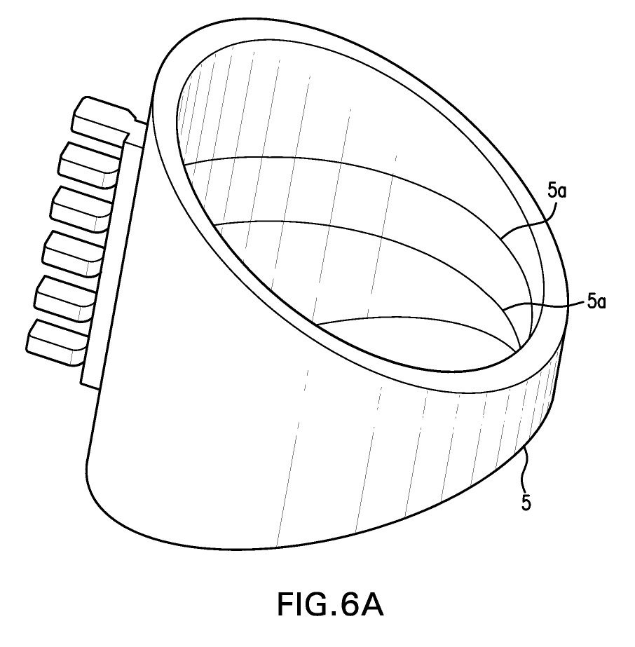

FIG. 6B displays a partial, front perspective view of a panel and joint of the child safety gate in accordance with the example embodiment of the present invention.

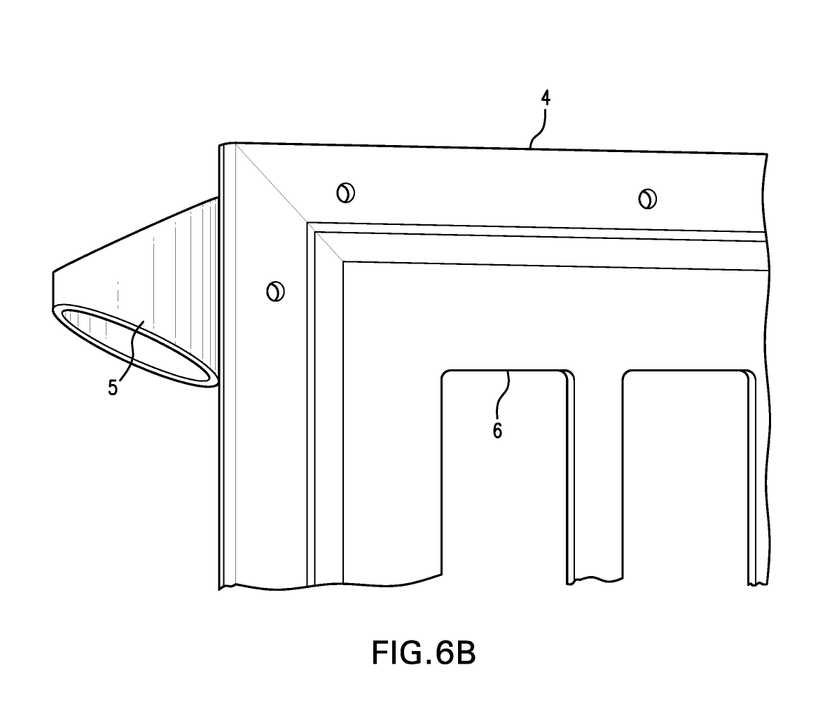

FIG. 7 displays a front perspective view of multiple panels of the child safety gate in accordance with the example embodiment of the present invention.

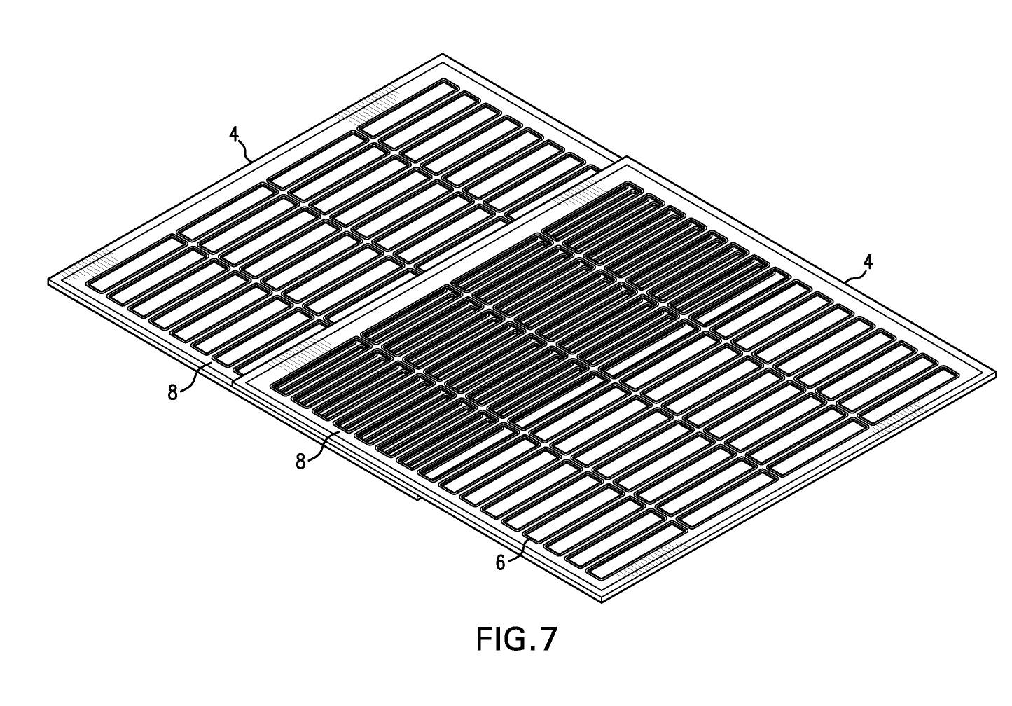

FIG. 8 displays a front perspective view of a locking mechanism of the child safety gate in accordance with the example embodiment of the present invention.

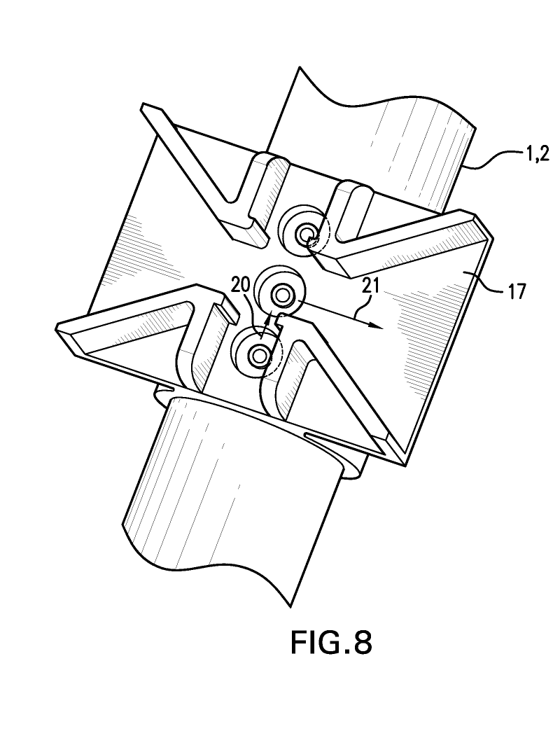

FIG. 9 displays a partial, side perspective view of a panel of the child safety gate in accordance with the example embodiment of the present invention.

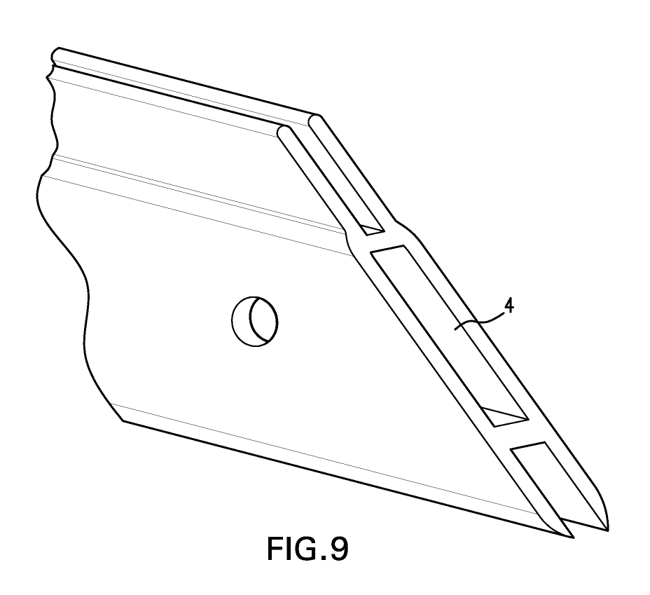

FIG. 10 displays a partial, front perspective view of the child safety gate in a closed configuration in accordance with the example embodiment of the present invention.

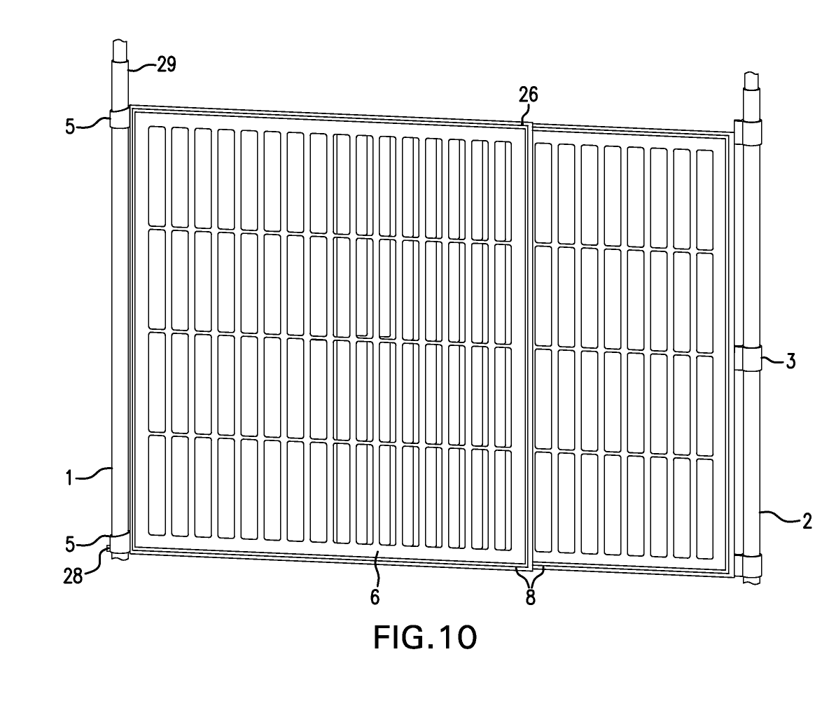

FIG. 11 displays a top, perspective view of a connector of the child safety gate in accordance with the example embodiment of the present invention.

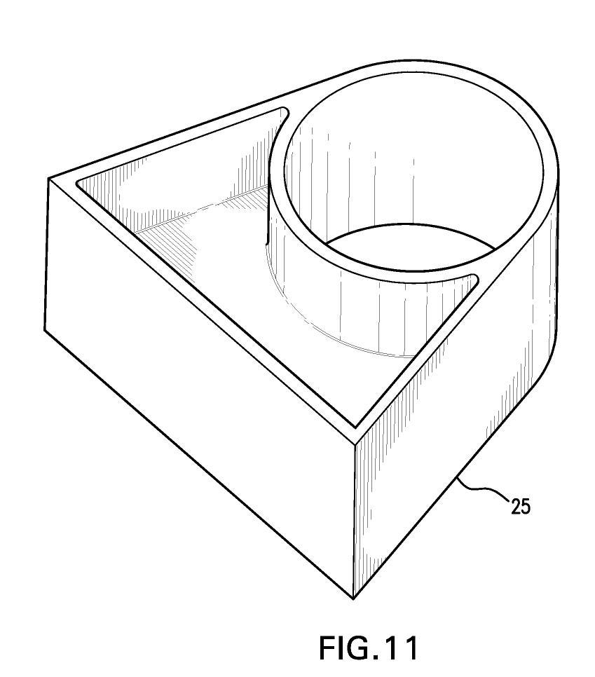

FIG. 12 displays a partial, front perspective view of a child safety gate, in accordance with an example embodiment of the present invention, with arrows indicating the directions of movement and adjustability of various components thereof.

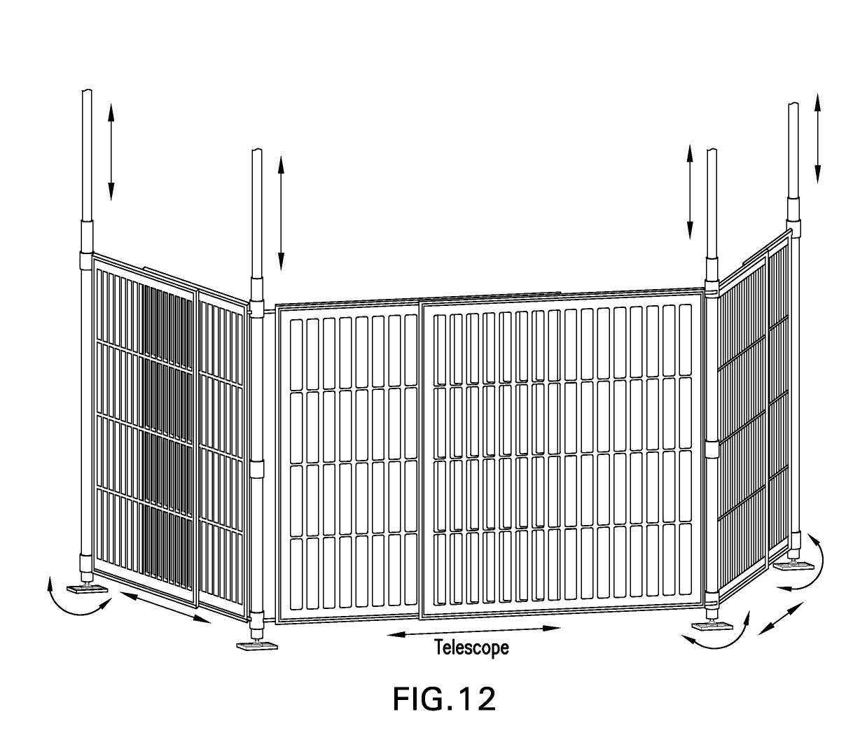

FIG. 13 displays a front perspective view of a supplemental bracket of the child safety gate in accordance with an example embodiment of the present invention.

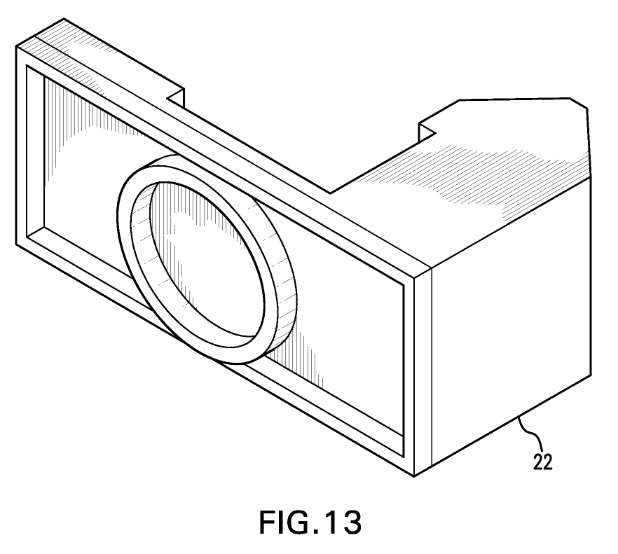

### DETAILED DESCRIPTION

Support 1 is formed by sliding tube 10 into telescope tube 9 and can be adjusted to fit the height of the door frame 11. The support 1 is secured in the door frame 11 using a tension device 12 similar to a screw thread or push rod. Another important feature is that the support 1 is equipped with swivel plates 13 at both ends, making it perfectly adaptable to the door frame 11. The swivel plates 13 are equipped with an anti-slip material, such as double-sided tape 15. The gate 8 can be adjusted to fit door width using gate 8, which includes telescopic panels 4. Mounting the gate 8 on support bars 1,2 eliminates the danger of a threshold. Support 2 is equipped with locking mechanism 17, which fits in the connectors of fastening 3. The locking mechanism 17 and fastening 3 can be made even safer by setting them so that several simultaneous actions are necessary to open the gate. Another possibility for preventing gate 8 from being opened accidentally is to affix supplemental brackets 22 to the base 23 and top 24 of the door frame 11, thereby securing the supports 1,2 on the sides of the door frame 11, leaving the opening completely obstacle free. Supports 1,2 can be additionally fixed to the door frame 11 using double-sided tape 15. The child safety gate 8 is especially user friendly and child-proof when used with the electronic remote control system 27.

Special designs can be used to prevent pets or unauthorized persons from passing through the gate 8. Gates 8 made of see-thru or grated plastic, or which have a pattern provide a clear view though the gate 8.

The telescopic function of the individual components come in very handy when using more than one child safety gate 8 in combination in order to secure larger passages or stairwells, insuring a perfect fit.

The slanted joint 5 in combination with a slanted surface 28 causes the gate 8 to close automatically. The gate 8 can also be equipped with a spring 29 if the weight of the gate 8 itself is insufficient. An overlay 28 can be placed on support 1 to adjust for height.

### Component Description:

| No. | Description | Figure No. |
|---|---|---|
| 1, 2 | Support | 1, 4, 5, 8, 10 |
| 3 | Fastening | 2A, 2B, 10 |
| 4 | Panel | 9, 2B, 3, 6B, 7 |
| 5 | Joint | 6A, 6B, 1, 10 |
| 6 | Slat | 3, 2B, 6B, 7, 10 |
| 8 | Gate with telescopic panels | 4, 10 |
| 9 | Telescoping tube | 1 |
| 10 | Tube | 1 |
| 11 | Door frame | 4 |
| 12 | Tension device | 5, 4 |
| 14 | Floor | 4 |
| 15 | Double-sided tape | 5, 1 |
| 16 | Hinge/Fastener with toothed connectors | 2, 6A |
| 17 | Locking mechanism | 8 |
| 19 | No threshold | 4 |
| 20, 21 | Simultaneous actions for opening | 8 |
| 22 | Supplemental bracket | 13 |
| 23 | Floor area of door frame | 4 |
| 24 | Upper area of door frame | 4 |
| 25 | Connector | 11, 4 |
| 26 | Screws for gate | 10 |
| 27 | Electronic remote control system | 4 |
| 28 | Slanted surface | 10 |
| 29 | Spring | 10 |

What is claimed is:

1. A child safety gate for doorways and stairwells comprising a gate, a swivel mounted on one or two supports, wherein said supports are vertically clamped in a doorway or stairwell, thereby creating no threshold.

2. The gate of claim 1, further comprising one or more sliding panels which can be adjusted to the width of said doorway or passage.

3. The gate of claim 1, wherein said supports comprise a plurality of tubes placed together to form a telescopic support.

4. The gate of claim 1, comprising joints on the ends of the supports which are equipped with one or more tension devices, such as a threaded screw, eccentric tappet, or spring, allowing the gate to be firmly jammed in the doorway.

5. The gate of claim 1, comprising a special joint that renders the gate adaptable to an available surface on said doorway or stairwell, making the gate form-fitting to the doorway or stairwell.

6. The gate of claim 1, wherein the ends of said supports are equipped with an anti-slip surface.

7. The gate of claim 1, further comprising an electromagnetic motor which can be used to open or close the gate, and an optional mechanism for remotely controlling said gate.

8. The gate of claim 1, comprising fastenings such as double-sided tape, making it possible to mechanically affix a screen.

9. The gate of claim 1, further comprising a child-proof locking mechanism which requires several simultaneous actions in order to be opened.

10. The gate of claim 1 by being of such stability and size that it prevents pets, children, handicapped persons, as well as unauthorized persons from passing.

11. The gate of claim 1, further comprising two see-through, interlocking panels, making it adaptable to the width of said doorway or stairwell.

12. The gate of claim 1, comprising three or more supports capable of being jammed between floor and ceiling, thereby making it possible to use several safety gates together to form a stairwell gate, to secure large passages, or to secure more than one stairwell, wherein each screen or panel can be opened or swivelled individually, and each individual gate is telescopic and can be adapted to the individual passage.

13. The gate of claim 1, further comprising panels which have holes in them or are solid and have different patterns on them.

14. The gate of claim 1, further comprising one or more panels which are reinforced, glued, or screwed in place using slats.

15. The gate of claim 14, further comprising elements which allow the panels which are affixed to the slats to be adjusted.

16. The gate of claim 1, further comprising low-friction, tube-like plastic hinges, and pre-drilled holes for the support tubes equipped with ring-shaped beads to minimize friction.

17. The gate of claim 1, further comprising one or more locking mechanisms equipped with comb-shaped attachments which make it possible to firmly affix slats through jamming.

18. The gate of claim 1, further comprising alternate, angular, end pieces which can be used to secure the supports in front of as well as on the side of passages.

19. The gate of claim 1, which closes by itself when used with a slanted joint and the appropriate slanted support, with or without a spring.
